(19) United States
(12) Patent Application Publication
(10) Pub. No.: US 2013/0307657 A1
(43) Pub. Date: Nov. 21, 2013

(54) SURFACE MOUNT INDUCTOR

(71) Applicant: TOKO, INC., Tsurugashima-shi (JP)

(72) Inventors: Takeo OHAGA, Tsurugashima-shi, Saitama-ken (JP); Masaaki TOTSUKA, Tsurugashima-shi, Saitama-ken (JP); Kunio SASAMORI, Tsurugashima-shi, Saitama-ken (JP)

(21) Appl. No.: 13/889,413

(22) Filed: May 8, 2013

(30) Foreign Application Priority Data
May 18, 2012 (JP) JP 2012-114195

(51) Int. Cl. H01F 27/29

(52) U.S. Cl. CPC H01F 27/292
USPC 336/192

(57) ABSTRACT

A surface mount inductor includes: a drum core including a spool having an upper collar and a lower collar; a coil wound around the drum core; and a ring core arranged on the drum core, wherein the metal terminals include first and second tongues projecting to an outer periphery of the lower collar, the ring core includes convex sections projecting to a lower surface from an edge, side surfaces of the first tongue and the second tongue sandwich side surfaces of the convex sections, and tip sections of the first tongue and the second tongue fix the ring core from below.

### CROSS REFERENCE TO RELATED APPLICATIONS

This application is based upon and claims the benefit of priority from the prior Japanese Patent Application No. 2012-114195, filed on May 18, 2012, the entire contents of which are incorporated herein by reference.

### BACKGROUND OF THE INVENTION

The present invention relates to a low profile surface mount inductor including a ring core arranged on an outer periphery of a drum core, the ring core surrounding the drum core.

An inductor including a coil wound around a drum core and including a ring core arranged on an outer periphery of the drum core is used for a choke coil of a DC/DC converter or the like. Along with the reduction in the size and thickness of electronic devices, reduction in the height of the inductor is also demanded. Recently, a low profile inductor including metal terminals directly adhered to a bottom surface of a drum core has been in use (Japanese Patent Laid-Open Nos. 2009-176954 and 2005-340607).

In general, an inductor formed by combining a drum core and a ring core is provided with a gap at a predetermined spacing between the drum core and the ring core to adjust electrical characteristics, such as inductance characteristics and a superimposed direct current value.

The electrical characteristics of the inductor are changed by adjusting the spacing of the gap. The spacing of the gap is about 0.1 mm to 0.50 mm, and this is significantly small. Therefore, variations in the assembly cause variations in the electrical characteristics of the inductor.

The spacing of the gap needs to be constant to reduce the variations in the electrical characteristics of the inductor.

FIGS. 3A to 3D are schematic plan views illustrating examples of the gap between the drum core and the ring core of the inductor formed by combining the drum core and the ring core. FIG. 3A shows a normal gap of the inductor. FIG. 3B shows a case where the position of the drum core is decentered. FIG. 3C shows a case where the spacing of the gap is enlarged. FIG. 3D shows a case where spacers are inserted to the gap.

As shown in FIG. 3A, a drum core 2 and a ring core 3 are arranged in the normal inductor so that a spacing d₀ of a gap 6 between the drum core 2 and the ring core 3 is uniform throughout the entire circumference.

Meanwhile, the drum core 2 is decentered, and part of the drum core 2 and the ring core 3 comes into contact in the inductor shown in FIG. 3B. Although an initial inductance value is greater than that of the inductor shown in FIG. 3A, the inductance value rapidly decreases with an increase in a direct current. This reduces a maximum superimposed direct current.

FIG. 3C shows a case where the spacing of the gap 6 is enlarged to prevent the drum core 2 and the ring core 3 from coming into contact with each other even if there is some mislocation. If a spacing d₁ of the gap 6 is enlarged as in FIG. 3C (d₀<d₁), the initial inductance value is reduced, and the number of windings needs to be increased. This poses a problem that direct current resistance increases.

Consequently, spacers 7 can be inserted to the gap 6 as shown in FIG. 3D. The spacers 7 may be temporarily used in the assembly or may be incorporated into the inductor.

However, the thickness of the spacers 7 needs to be reduced to 0.01 mm to 0.40 mm when the spacers 7 are used only in the assembly. There is a problem in the durability of the spacers 7, and there is a problem that the manufacturing cost increases.

There is a problem of an increase in the material cost when the spacers 7 are incorporated into the inductor. Metal terminals can also function as spacers. However, a magnetic flux penetrates through the metallic spacers, and an eddy current loss occurs at the metal terminals. There is a problem that the characteristics of the inductor are reduced.

### SUMMARY OF THE INVENTION

To solve the problems, the present invention provides a surface mount inductor including:

a drum core including a spool provided with collars, the collars including an upper collar and a lower collar provided on opposite ends of the spool; a coil wound around the spool; a pair of metal terminals arranged on a lower surface of the lower collar; and a ring core arranged on an outer periphery of the drum core, wherein

each of the metal terminals includes a plurality of tongues projecting in different peripheral directions of the lower collar,

at least two of the plurality of tongues include stepped sections abutting against an outer edge of the lower collar of the drum core, and

at least two of the plurality of tongues abut against a lower end surface of the ring core and sandwich a convex section provided on the lower end surface of the ring core from both sides.

According to the surface mount inductor of the present invention, the drum core and the ring core can be positioned without enlarging the spacing of the gap and without using the spacers. As a result, a surface mount inductor with stable electrical characteristics can be inexpensively provided.

### BRIEF DESCRIPTION OF THE DRAWINGS

FIGS. 1A and 1B are perspective views of a surface mount inductor of the present invention;

FIG. 2 is an exploded perspective view of FIG. 1; and

FIGS. 3A to 3D are schematic plan views for describing gaps of conventional surface mount inductors.

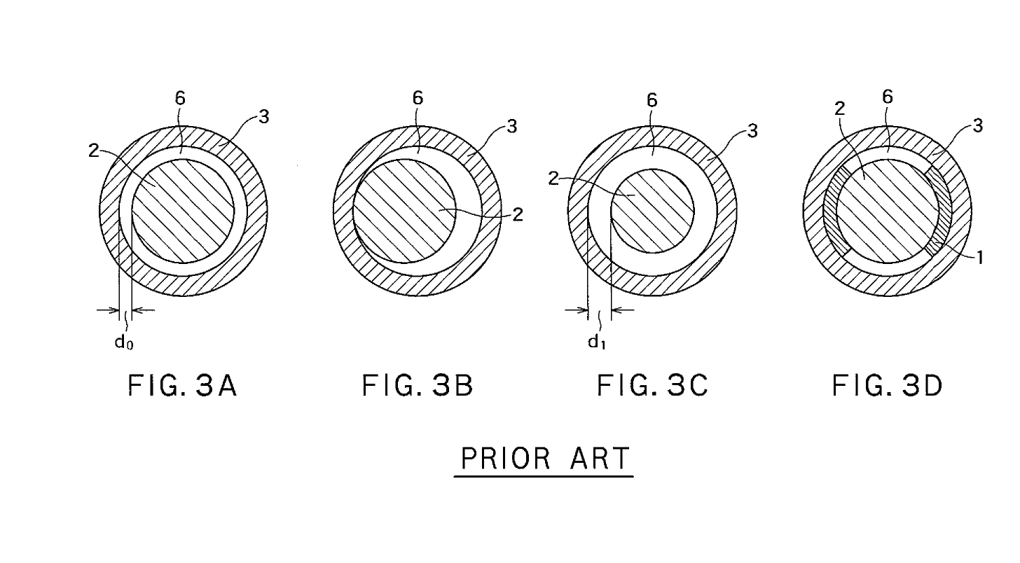

### DESCRIPTION OF THE PREFERRED EMBODIMENT

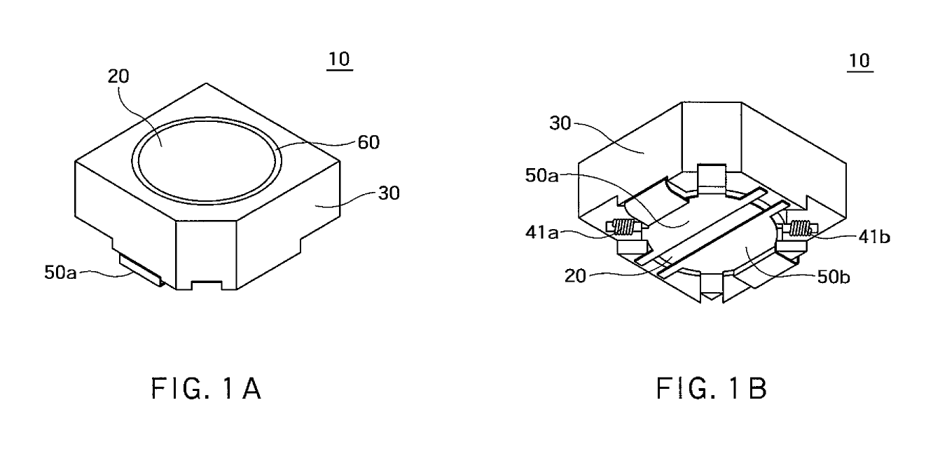

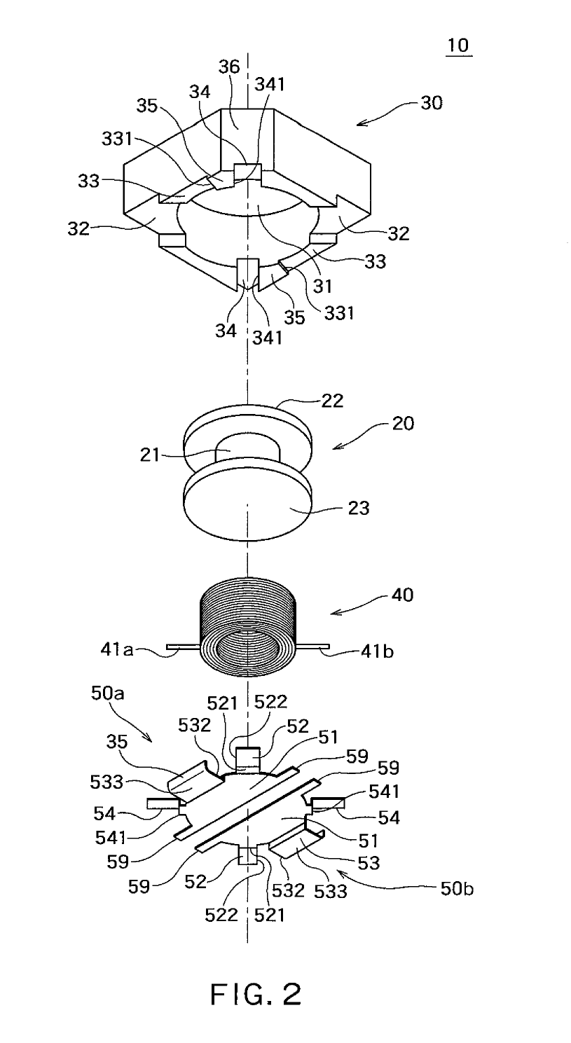

An embodiment of a surface mount inductor of the present invention will now be described with reference to FIGS. 1A, 1B and 2. FIGS. 1A and 1B are perspective views of the surface mount inductor of the present invention. FIG. 1A shows a perspective view from above. FIG. 1B shows a perspective view from below. FIG. 2 shows an exploded perspective view of the surface mount inductor shown in FIGS. 1A and 1B.

As shown in FIGS. 1A, 1B, and 2, a surface mount inductor 10 of the present invention includes: a drum core 20; a coil 40 including an insulation-coated lead wire wound around the drum core 20; a ring core 30 arranged on an outer periphery of the drum core 20 through a gap 60; and a pair of metal terminals 50a and 50b arranged on a bottom surface of the drum core 20.

The drum core 20 includes a disc-shaped upper collar 22 and a lower collar 23 on opposite ends of a spool 21, and the coil 40 is wound around the spool 21.

The ring core 30 has a substantially rectangular outer shape and includes, at a center, an insertion hole 31 having a diameter slightly larger than outside diameters of the collars 22 and 23 of the drum core 20. On a bottom surface, the ring core 30 includes: lower stage surfaces 32 and 32 formed by cutting out one of the pairs of opposing corners; and grooves 34 and 34 on the other pair of opposing corners, each of the grooves 34 including a stepped section 341 between a lower end surface 35 and the groove 34. On one of the pairs of opposing sides adjacent to the lower stage surfaces 32, upper stage surfaces 33 and 33 cut out lower than the lower stage surfaces 32 are provided, each of the upper stage surfaces 33 including a stepped section 331 between the lower end surface 35 and the upper stage surface 33.

As a result, convex sections are formed by the stepped sections 331 and 341 on the lower end surface 35. On one corner, the ring core 30 includes a chamfered section 36 chamfered to indicate polarity of the surface mount inductor.

The pair of metal terminals 50a and 50b are formed by punching a predetermined shape on a lead frame made of a continuous thin metal plate. Each of the metal terminals 50a and 50b includes: a bottom section 51 in a semicircular shape; tongues 52, 53, and 54 projecting in peripheral directions from over an arc of the bottom section 51; and connection sections 59 and 59 connected to the lead frame.

The tongue 52 is bent upward like a crank to provide a stepped section 521. The tongue 53 is once bent downward like a crank to provide a mount section 533 that serves as a mount terminal. A tip of the tongue 53 is bent in an upper direction along a side surface of the ring core 30. The tongue 54 is bent upward like a crank to provide a stepped section 541.

In the assembly of the surface mount inductor 10, the metal terminals 50a and 50b are adhered and fixed to the bottom surface of the lower collar 23 so that the stepped sections 521 and 541 abut against the outer periphery of the lower collar 23 of the drum core 20.

Terminal sections 41a and 41b of the coil 40 are tied up to the metal terminals 50a and 50b, respectively. The tie-up sections are immersed in a solder bath to remove the insulation coating, and the terminals sections 41a and 41b and the metal terminals 50a and 50b are separately and electrically connected.

The ring core 30 is arranged on the outer periphery of the drum core 20, and an adhesive is injected to the gap 60 to adhere and fix the drum core 20 and the ring core 30.

In this case, a side end surface 522 of the tongue 52 is abutting against the stepped section 341, and a side end surface 532 of the tongue 53 is abutting against the stepped section 331. In this way, the tongues 53 and 52 sandwich the lower end surface 35 from both sides. The tip of the tongue 52 is abutting against the groove 32, and the tip of the tongue 53 is abutting against the upper stage surface 33.

In the surface mount inductor 10, the tongues 52 and 53 position the ring core 30 in a horizontal direction and position the bottom surface of the ring core 30. Positioning of the metal terminals 50a and 50b relative to the drum core 20 is relatively easy. Therefore, the structure of the surface mount inductor allows accurate positioning of the drum core and the ring core without using spacers, and the gap can be constant. As a result, a surface mount inductor with stable characteristics can be inexpensively provided.

Since the tip of the tongue 53 is bent along the sidewall of the ring core 30, a fillet can be easily checked when the surface mount inductor 10 is mounted on a printed circuit board.

Although an embodiment of the present invention has been described with reference to the drawings, the present invention is not limited to this.

For example, the tongues 52 abut against the drum core 20 at the stepped section 521, and the side end surfaces 522 abut against the ring core 30 in the embodiment. However, the tongues may be divided into tongues abutting against the drum core 20 and tongues abutting against the ring core 30. Furthermore, the terminal section of the coil may be tied up to the tip section of the tongue 53.

More specifically, only at least two tongues that sandwich the convex section from both sides and at least two tongues that support the drum core from below are required. The connection sections may also be used as tongues.

What is claimed is:

1. A surface mount inductor comprising: a drum core comprising a spool provided with collars, the collars comprising an upper collar and a lower collar provided on opposite ends of the spool; a coil wound around the spool; a pair of metal terminals arranged on a lower surface of the lower collar; and a ring core arranged on an outer periphery of the drum core, wherein
each of the metal terminals comprises a plurality of tongues projecting in different peripheral directions of the lower collar,
at least two of the plurality of tongues comprise stepped sections abutting against an outer edge of the lower collar of the drum core, and
at least two of the plurality of tongues abut against a lower end surface of the ring core and sandwich a convex section provided on the lower end surface of the ring core from both sides.

2. The surface mount inductor according to claim 1, wherein
a terminal section of the coil is tied up to one of the plurality of tongues.

3. The surface mount inductor according to claim 2, wherein
the plurality of tongues are arranged below an upper surface of the lower collar.

4. The surface mount inductor according to claim 3, wherein
a convex section projecting below the lower collar is arranged on one of the plurality of tongues, and the convex section serves as a mount terminal.
